(19) United States
(12) Patent Application Publication
(10) Pub. No.: US 2016/0340542 A1
(43) Pub. Date: Nov. 24, 2016

(54) THREE DIMENSIONAL PRINTING FILAMENT COMPOSITION FOR REDUCING HARMFUL SUBSTANCES AND A METHOD FOR PREPARING THE SAME

(71) Applicant: BnK Co., Ltd., Ulsan (KR)

(72) Inventors: Sung Jin KIM, Ulsan (KR); Young Soo KIM, Ulsan (KR); Young Hyeok KIM, Ulsan (KR); Jung Nyu BAEK, Ulsan (KR); Soo Young HUH, Gyeongsangnam-do (KR); Sung Ho PARK, Gyeongsangnam-do (KR)

(21) Appl. No.: 14/856,575

(22) Filed: Sep. 17, 2015

(30) Foreign Application Priority Data
May 18, 2015 (KR) 10-2015-0069105
Sep. 17, 2015 (KR) 10-2015-0131672

(51) Int. Cl. C09D 155/02; B29C 47/00

(52) U.S. Cl. CPC C09D 155/02; B29C 47/0004; B33Y 70/00

(57) ABSTRACT

Provided is a three dimensional printing filament composition for reducing harmful substances including a thermoplastic resin at 100 parts by weight and at least one of a reducing agent in which a catalyst is supported on a support, and a photocatalyst at 0.1 to 10 parts by weight, and a method of preparing the same.

### CROSS-REFERENCE TO RELATED APPLICATION

This application claims priority to and the benefit of Korean Patent Application Nos. 10-2015-0069105 filed on May 18, 2015 & 10-2015-0131672 filed on Sep. 17, 2015, the disclosure of which is incorporated herein by reference in its entirety.

### BACKGROUND

1. Field of the Invention

The present invention relates to a three dimensional printing filament composition for reducing harmful substances and a method of preparing the same, and more specifically, to a three dimensional printing filament composition for reducing harmful substances which are generated while articles are manufactured or from a final product and a method of preparing the same.

2. Discussion of Related Art

A 3D printer is a device which produces a product by processing and laminating materials such as liquid and powder resins, metal powders, solids or the like based on design data, and 3D printer technology may be classified into fused deposition modeling (FDM), selective laser sintering (SLS) and stereo lithography apparatus (SLA) methods depending on the material.

The FDM method is a method of melting a thermoplastic material in a filament form in nozzles and outputting the thermoplastic material to have a thin film form, the SLS method is a method of selectively radiating laser or adhesive to powders to output a product, and the SLA method is a method of scanning a laser beam to a photocurable material to output a product.

Among them, the FDM method has lower production costs and is more suitable for the device with a reduced size as compared to other methods, and thus the range of application of the FDM method is expanded from commercial to domestic products, contributing to popularization of the 3D printer. However, harmful substances are generated from most of the materials used in the FDM method, and especially, the harmful substances include a volatile organic compound (VOC).

The VOC in itself is harmful, and is volatilized into the air while producing odor or ozone. Further, the VOC is known as a carcinogen which may cause disorders of a nervous system through skin contact or respiratory inhalation, and thus may result in health problems of users.

Meanwhile, environmental issues have emerged as a major concern in society, and thereby the regulations on the VOC tend to be more strict. Accordingly, it is required to add a separate process of removing the VOC in a process of producing a filament composition or a production process using the filament composition.

Further, as the range of application of 3D printer technologies have been expanded to industries such as biotechnology, health care, household goods or the like which are closely related to everyday life besides the manufacturing industry, there is a need for the development of technology which may reduce harmful substances generated from the filament.

### SUMMARY OF THE INVENTION

In order to resolve the above-described problem of the prior art, the present invention is directed to providing a three dimensional printing filament composition for reducing harmful substances, and a method of preparing the same.

In order to achieve the above-described objective, according to an aspect of the present invention, there is provided a three dimensional printing filament composition for reducing harmful substances, including a thermoplastic resin at 100 parts by weight; and at least one selected from a reducing agent in which a catalyst is supported on a support, and a photocatalyst at 0.1 to 10 parts by weight.

According to an embodiment of the present invention, the support may be one selected from the group consisting of zeolite, silica, alumina, sodium chloride, glass beads, activated carbon, and a mixture of at least two thereof.

According to the embodiment of the present invention, the support may have an average diameter in a range of 1 to 50 μm.

According to the embodiment of the present invention, the catalyst may be one selected from the group consisting of calcium, zinc, sodium, copper, nickel, chromium, manganese, iron, vanadium, palladium, platinum, ruthenium, rhodium, gold, silver, Fe—Mo alloy, Fe—Mo—Ti alloy, Co-Fi-Mo alloy, As—Nb—Mo alloy, Bi—Mo alloy, Fe—Sb alloy, Mg—Ge alloy, Mg—Fe alloy, and a mixture of at least two thereof.

According to the embodiment of the present invention, the catalyst may have an average diameter in a range of 10 to 100 nm.

According to the embodiment of the present invention, the photocatalyst may be one selected from the group consisting of anatase titanium dioxide, rutile titanium dioxide, zinc oxide, cadmium sulfide, zirconium oxide, vanadium oxide, tin oxide, tungsten oxide, and a mixture of at least two thereof. According to the embodiment of the present invention, the three dimensional printing filament composition for reducing harmful substances may further include a reinforcing agent at 5 to 80 parts by weight based on 100 parts by weight of the thermoplastic resin, the reinforcing agent being one selected from the group consisting of graphene, carbon nanotubes, carbon fibers, glass fibers, metal powders, ceramic powders, and a mixture of at least two thereof.

Further, in order to achieve the above-described objective, according to another aspect of the present invention, there is provided a method of preparing a three dimensional printing filament composition for reducing harmful substances, including: (a) preparing a mixture by mixing 100 parts by weight of a thermoplastic resin, and 0.1 to 10 parts by weight of a reducing agent in which a catalyst is supported on a support or a photocatalyst (S100); (b) preparing an extrudate by extruding the mixture using a single screw extruder or a twin screw extruder (S200); and (c) cutting and pelletizing the extrudate (S300).

According to an embodiment of the present invention, the support may be one selected from the group consisting of zeolite, silica, alumina, sodium chloride, glass beads, activated carbon, and a mixture of at least two thereof.

According to the embodiment of the present invention, the support may have an average diameter in a range of 1 to 50 μm.

According to the embodiment of the present invention, the catalyst may be one selected from the group consisting of calcium, zinc, sodium, copper, nickel, chromium, manganese, iron, vanadium, palladium, platinum, ruthenium, rhodium, gold, silver, Fe—Mo alloy, Fe—Mo—Ti alloy, Co-Fi-Mo alloy, As—Nb—Mo alloy, Bi—Mo alloy, Fe—Sb alloy, Mg—Ge alloy, Mg—Fe alloy, and a mixture of at least two thereof.

According to the embodiment of the present invention, the catalyst may have an average diameter in a range of 10 to 100 nm.

According to the embodiment of the present invention, the photocatalyst may be one selected from the group consisting of anatase titanium dioxide, rutile titanium dioxide, zinc oxide, cadmium sulfide, zirconium oxide, vanadium oxide, tin oxide, tungsten oxide, and a mixture of at least two thereof. According to the embodiment of the present invention, 5 to 80 parts by weight of a reinforcing agent may be further mixed based on 100 parts by weight of the thermoplastic resin in step (a), the reinforcing agent being one selected from the group consisting of graphene, carbon nanotubes, carbon fibers, glass fibers, metal powders, ceramic powders, and a mixture of at least two thereof.

According to the embodiment of the present invention, a ratio of length to diameter of the extruder may be in a range of 25 to 50:1.

According to the embodiment of the present invention, a driving speed of the extruder may be in a range of 50 to 500 rpm.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 illustrates a method of preparing a three dimensional printing filament composition for reducing harmful substances according to an embodiment of the present invention.

### DETAILED DESCRIPTION OF EXEMPLARY EMBODIMENTS

Hereinafter, embodiments of the present invention will be described in detail with reference to the accompanying drawings. However, embodiments of the present invention may be implemented in several different forms, and are not limited to embodiments described herein. In addition, parts irrelevant to description are omitted in the drawings in order to clearly explain embodiments of the present invention. Similar parts are denoted by similar reference numerals throughout this specification.

Throughout the specification, when a portion “includes” an element, another element may be further included, rather than excluding the existence of the other element, unless otherwise described.

Three Dimensional Printing Filament Composition

In order to achieve the above-described objective, according to an aspect of the present invention, there is provided a three dimensional printing filament composition for reducing harmful substances including a thermoplastic resin at 100 parts by weight and at least one of a reducing agent in which a catalyst is supported on a support, and a photocatalyst at 0.1 to 10 parts by weight.

The three dimensional printing filament composition for reducing harmful substances may be a composition including a thermoplastic resin as a matrix phase. In general, a thermoplastic resin and a thermosetting resin may be used as the matrix phase of the three dimensional printing filament composition, but the thermosetting resin has a problem of curing and impact resistance, causing a difficulty in the subsequent forming process.

On the other hand, the thermoplastic resin has an excellent formability as compared to the thermosetting resin, and thus it is preferred to use the thermoplastic resin as the matrix phase.

The thermoplastic resin may be one of commodity plastics selected from the group consisting of acrylonitrile butadiene styrene, polyethylene, polypropylene, polyvinyl chloride, polyurethane, and a mixture of at least two thereof, but is not limited thereto.

The term “commodity plastics” used in the present specification refers to plastics having the physical properties of general plastics.

The thermoplastic resin may be one of engineering plastics or super engineering plastics selected from the group consisting of polycarbonate, polybutylene terephthalate, polyoxymethylene, polyamide 6, polyamide 66, modified polyphenylene oxide, polyphthalamide, liquid crystal polymer, polyether ether ketone, polyimide, polyamide and a mixture of at least two thereof, but is not limited thereto.

The term “engineering plastics” used in the present specification refers to plastics having the physical properties which may complement thermal properties and mechanical strength which are the greatest drawbacks of commodity plastics and may be applied to engineering materials, and the term “super engineering plastics” refers to highly functional plastics having more improved thermal and mechanical properties than engineering plastics.

The commodity plastics and the engineering or super engineering plastics may be used independently of each other as the matrix phase of the three dimensional printing filament composition for reducing harmful substances, and may also be mixed and used as necessary in consideration of the purpose of final products, production costs, etc. For example, when it is intended to realize the intrinsic properties of engineering or super engineering plastics, it is not easy to commercially obtain the engineering or super engineering plastics, and production costs may increase, and thus commodity plastics may be mixed in a certain ratio and used.

The three dimensional printing filament composition for reducing harmful substances may be prepared to include at least one of a reducing agent in which a catalyst is supported on a support, and a photocatalyst. Since materials used as the catalyst are generally expensive, the reducing agent may be prepared by supporting the catalyst on a support which may improve the reactivity by expanding a reaction area using a small amount of the catalyst or increase the adhesion with the catalyst. The support may be one selected from the group consisting of zeolite, silica, alumina, sodium chloride, glass beads, activated carbon, and a mixture of at least two thereof, preferably may be zeolite, and more preferably may be zeolite to which silica is further added to supplement the strength of zeolite, but is not limited thereto.

The support is a porous material having many pores, and thus may effectively enhance the reactivity by supporting the catalyst in pores. Further, the support is required to support the catalyst sufficiently, and a material which has no reactivity with the catalyst and is not sensitive to the change of a temperature may be selected as the support.

The support may have an average diameter in the range of 1 to 50 μm. When the average diameter of the support is less than 1 μm, the pore size is reduced, and thus the support rate of the catalyst may decrease. When the average diameter of the support is more than 50 μm, the surface area of the support is reduced, and thus the reactivity of the catalyst may decrease.

In general, the catalyst serves to adjust a reaction rate in a variety of processes. Here, the catalyst increasing the reaction rate is referred to as a positive catalyst, and the catalyst decreasing the reaction rate is referred to as a negative catalyst. According to the embodiment of the present invention, the catalyst supported on the support may reduce activation energy and increase the reaction rate, and thus may perform a reaction or activate a specific reaction in a low temperature range to selectively generate a product.

A metal catalyst, a noble metal catalyst, and an alloy catalyst including a mixture thereof may be used as the catalyst. The type of the catalyst may be one selected from the group consisting of calcium, zinc, sodium, copper, nickel, chromium, manganese, iron, vanadium, palladium, platinum, ruthenium, rhodium, gold, silver, Fe—Mo alloy, Fe—Mo—Ti alloy, Co-Fi-Mo alloy, As—Nb—Mo alloy, Bi—Mo alloy, Fe—Sb alloy, Mg—Ge alloy, Mg—Fe alloy, and a mixture of at least two thereof, but is not limited thereto.

Among the catalysts, the noble metal catalyst has the highest reactivity, but the noble metal catalyst may lead to an increase in production costs, and thus the metal catalyst may be mixed with the noble metal catalyst. The catalyst may be prepared using a wet method such as precipitation and spray pyrolysis, and a dry method such as mechanical grinding, electrical wire explosion, sputtering and evaporation, and the method of preparing the catalyst may be selected according to the type of the catalyst and the particle size to be implemented.

The catalyst may have an average diameter in the range of 10 to 100 nm. When the average diameter of the catalyst is less than 10 nm, the production costs of the catalyst may increase, and when the average diameter of the catalyst is more than 100 nm, the support rate on the support may be reduced, resulting in a decrease in reduction efficiency.

The photocatalyst starts to catalyze when being exposed to light, electrons and holes generated by the catalytic action each react with O₂, H₂O, or the like in the air to generate active oxygen such as OH radicals, superoxide anions, hydrogen peroxides or the like, and thereby various odors and harmful substances such as VOCs may be effectively reduced.

Further, the surface of the photocatalyst has high contamination resistance preventing the attachment of contaminants, and thus may have self-cleaning properties by which attached contaminants are easily washed by water.

The photocatalyst may be one selected from the group consisting of anatase titanium dioxide, rutile titanium dioxide, zinc oxide, cadmium sulfide, zirconium oxide, vanadium oxide, tin oxide, tungsten oxide, and a mixture of at least two thereof, but is not limited thereto.

Among the photocatalysts, the titanium dioxide has three structures of anatase, rutile and brookite. In the three structures, an anatase structure having excellent extinction properties has been preferred as a photocatalyst, but the research result that an anatase-rutile mixed structure formed by adding a suitable content of a rutile structure to the anatase structure has more excellent photocatalytic performance than the anatase structure was found. Accordingly, it is preferred to use a single structure or a mixed structure according to the photocatalytic performance to be implemented.

The content of at least one of the reducing agent and photocatalyst in which the catalyst is supported on the support may be in the range of 0.1 to 10 parts by weight. When the content of the reducing agent or photocatalyst is less than 0.1 parts by weight, the effect of reducing harmful substances such as VOCs may decrease, and when the content of the reducing agent or photocatalyst is more than 10 parts by weight, the content of the thermoplastic resin is relatively reduced, and thus the physical properties of the final product may decrease.

One of the reducing agent and the photocatalyst may be selectively used, or the combination thereof may be used as necessary. The photocatalyst may improve the performance of reducing harmful substances of the reducing agent itself.

Further, the three dimensional printing filament composition for reducing harmful substances may further include a reinforcing agent at 5 to 80 parts by weight based on 100 parts by weight of the thermoplastic resin, the reinforcing agent being one selected from the group consisting of graphene, carbon nanotubes, carbon fibers, glass fibers, metal powders, ceramic powders, and a mixture of at least two thereof.

The carbon fibers may be one selected from the group consisting of rayon-based carbon fibers, pitch-based carbon fibers, polyacrylonitrile-based carbon fibers, and mixtures of at least two thereof. The carbon fibers may be prepared by pyrolyzing organic precursor materials in the form of fibers, in other words, starting materials under inert atmosphere. Especially, it is important to increase the carbonization yield in the physical properties of carbon fibers. To this end, the preparation of polymeric precursor fibers having a controlled inner structure and high purity, a stable pretreatment process and carbonization process, and the like are required.

The carbon fibers may be classified into rayon-based carbon fibers, pitch-based carbon fibers, and polyacrylonitrile-based carbon fibers according to the precursor materials. Among them, high modulus carbon fibers prepared from the pitch-based carbon fibers and high strength carbon fibers prepared from the polyacrylonitrile-based carbon fibers are widely used. In the present invention, one of the rayon-based carbon fibers, pitch-based carbon fibers, and polyacrylonitrile-based carbon fibers may be selectively used, or a mixture of at least two thereof may be used as necessary.

The rayon-based carbon fibers may be prepared using special-grade viscous rayon with little defects. The carbonization yield is in the range of 2 to 20%, and the carbon fibers prepared using the viscous rayon may have a tensile strength in the range of 345 to 690 MPa, a tensile modulus in the range of 20 to 55 GPa, and a density in the range of 1.0 to 1.43 g/cm³.

The pitch-based carbon fibers may be prepared from petroleum pitches and coal pitches according to the raw material. The pitch is in the form in which a condensed benzene ring has an alkyl chain or several different types of organic compounds separated by an alkyl chain are mixed. Especially, precursor fibers prepared by liquid-crystal spinning of a mesophase pitch melt may maintain or improve the state of the axis orientation in the carbonization and graphitization processes, and thus may have a tensile modulus of about 830 GPa without being drawn.

The polyacrylonitrile-based carbon fibers may be prepared through the processes of preparing polyacrylonitrile-precursor fibers, and stabilization, carbonization and graphitization of the precursor fibers. More specifically, when a stabilization process is performed on a polyacrylonitrile which is a linear polymer as a starting material in the air at 200 to 300° C. for 1 to 2 hours, the precursor material may form a ladder structure which is thermally stable and is capable of enduring the carbonization process due to chain scission, crosslinking, dehydrogenation and cyclization reactions.

In the stabilization process, the precursor material may be drawn to have a shrinkage rate of 15% so as to maintain and improve the state of the orientation of the molecules. Further, the stabilization process entails complex and multistage chemical reactions, water, carbon dioxide, hydrogen cyanide or the like are emitted and thus a weight loss ranging from 5 to 8% may be caused, and the carbon content of the precursor fibers may be reduced from 68% to 62 to 65%. Thereafter, when the precursor fibers are carbonized at 1,200 to 2,500° C. under inert atmosphere, 45 to 55 wt % of the carbon fibers may be obtained based on the total weight of the precursor fibers.

Almost all the polyacrylonitrile-based carbon fibers consist of carbon, and thus the weight loss may be minimized even in the graphitization process at 2,500° C. or more, and a structural change in which the amount of crystal orientation in the direction of the axis of the carbon fibers is increased may occur. Accordingly, the mechanical properties of the carbon fibers may be improved.

According to the heat treatment temperature during the graphitization process, when the heat treatment is carried out at 3,000° C. or more, the tensile modulus of the polyacrylonitrile-based carbon fibers may be 517 GPa or more. A boron compound may be used as a catalyst so as to reduce the process temperature and process time in the graphitization process.

Meanwhile, the content of the rayon-based carbon fibers or pitch-based carbon fibers may be in the range of 10 to 80 parts by weight based on 100 parts by weight of the thermoplastic resin, and the content of the polyacrylonitrile-based carbon fibers may be in the range of 5 to 70 parts by weight based on 100 parts by weight of the thermoplastic resin.

When the content of the rayon-based carbon fibers or pitch-based carbon fibers is less than 10 parts by weight, the mechanical properties may be reduced, and when the content of the rayon-based carbon fibers or pitch-based carbon fibers is more than 80 parts by weight, the relative content of the thermoplastic resin may decrease, causing a decrease in the uniformity of the filament composition and an increase in production costs. Likewise, when the content of the polyacrylonitrile-based carbon fibers is out of the above-described range, the results are the same as the case in which the content of the rayon-based carbon fibers or pitch-based carbon fibers is out of the above-described range.

Meanwhile, the three dimensional printing filament composition for reducing harmful substances may further include a dispersant, a surfactant, and a lubricant. When the additives are included, the dispersibility of the reducing agent and photocatalyst may increase, and thus the filament composition may have an increased effect of reducing harmful substances. The additives may be selected according to the types of the support, catalyst, and photocatalyst and the reduction efficiency to be implemented.

Method of Preparing Three Dimensional Printing Filament Composition

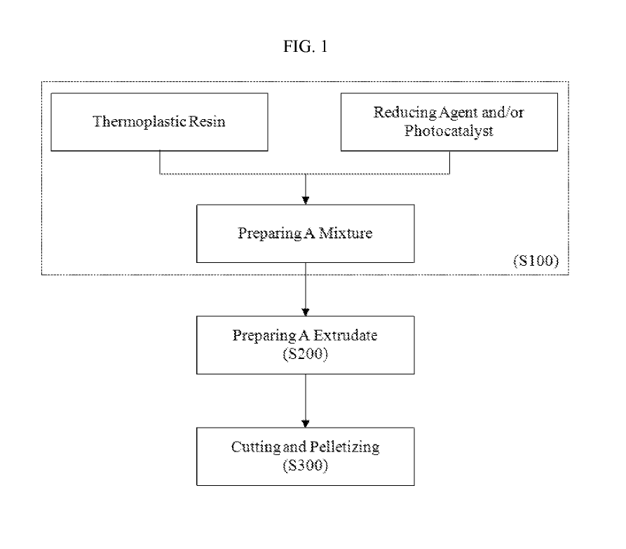

FIG. 1 illustrates a method of preparing a three dimensional printing filament composition for reducing harmful substances according to an embodiment of the present invention.

Referring to FIG. 1, another aspect of the present invention provides a method of preparing a three dimensional printing filament composition for reducing harmful substances, including: (a) preparing a mixture by mixing 100 parts by weight of a thermoplastic resin, and 0.1 to 10 parts by weight of a reducing agent in which a catalyst is supported on a support or a photocatalyst (S100); (b) preparing an extrudate by extruding the mixture using a single screw extruder or a twin screw extruder (S200); and (c) cutting and pelletizing the extrudate (S300).

In step (a) (S100), the thermoplastic resin may be a commodity plastic, an engineering or super engineering plastic. The commodity plastic and the engineering or super engineering plastic may be used independently of each other as the matrix phase of the three dimensional printing filament composition for reducing harmful substances, and may also be mixed and used as necessary in consideration of the purpose of final products, production costs, etc.

Further, 5 to 80 parts by weight of a carbon fiber may be further mixed based on 100 parts by weight of the thermoplastic resin in step (a) (S100), the carbon fiber being one selected from the group consisting of a rayon-based carbon fiber, a pitch-based carbon fiber, a polyacrylonitrile-based carbon fiber, and a mixture of at least two thereof. The type, preparation method, and content of the carbon fiber are as described above.

Meanwhile, the extruder which may be used in step (b) (S200) may be a single screw extruder or a twin screw extruder. The terms “single screw extruder” and “twin screw extruder” used in the present specification refer to screw-type extruders having one screw and two screws, respectively.

The single screw extruder is suitable for extrusion molding of most of thermoplastic resins, and the twin screw extruder is frequently used for producing large-aperture pipes such as polyvinyl chloride (PVC) pipes. Although the twin screw extruder has more complicated structure than the single screw extruder and is expensive, but the extrusion amount is large and constant, and stable extrusion may be realized despite a low driving speed, and thus the twin screw extruder is widely used.

Although not shown in the drawings, the extruder may be designed such that, when a thermoplastic resin, reducing agent, and photocatalyst are fed through a raw material inlet, the fed thermoplastic resin, reducing agent, and photocatalyst are melt-mixed by the screw to prepare a mixture, the mixture is extruded to be a filament, and the extrudate is cut.

When the extruder performs extrusion spinning on the mixture, the screw temperature of the extruder may be adjusted to 180 to 260° C., and preferably, to 230 to 250° C. In consideration of the possibility of destruction of the mixture due to the pressure and temperature applied to the mixture during the extrusion process, the screw temperature of the extruder may be differently adjusted according to the type of the thermoplastic resin.

In general, the filament may be extruded to have a predetermined diameter, but when the average diameter of the filament which is previously extruded is different from that of a nozzle of a 3D printer, the use of the filament may be limited. Therefore, the extrudate may be cut and pelletized to allow for the subsequent or additional extrusion or use of the filament for the convenience of the follow-up process in step (c) (S300).

Meanwhile, the ratio of length to diameter of the extruder may be 25 to 50:1. The “ratio of length to diameter” of the extruder denotes the ratio between the length (L) and diameter (D) of the screw, and is one of the factors to decide the extrusion performance of the extruder. In general, the higher the “ratio of length to diameter” of the screw is, the higher the mixing effect and quality of the product are, and the less the deviation of the extrusion amount is. However, the ratio of length to diameter may be differently adjusted according to the type and properties of materials fed to the extruder.

When the ratio of length to diameter of the extruder is less than 25:1, the required level of the mixing effect may not be realized, and when the ratio of length to diameter of the extruder is more than 50:1, the size of the extruder and the capacity of a driving motor may be affected, causing a decrease in process efficiency.

Further, the driving speed of the extruder may range from 50 to 500 rpm. The driving speed of the extruder denotes the rotational speed of a screw provided in the extruder. When the driving speed of the extruder is less than 50 rpm, the dispersibility of the reducing agent and photocatalyst with respect to the thermoplastic resin may be reduced, and thus the effect of reducing harmful substances such as VOCs may decrease. When the driving speed of the extruder is more than 500 rpm, the number of revolution of a motor is notably larger than the number of revolution of the screw, and thus an excessive load may be applied to the motor and a speed reducer.

Hereinafter, the embodiments of the present invention will be described in detail.

### Example 1

1 part by weight of a reducing agent (average particle size: 5 μm) in which Na as a catalyst metal was supported on a zeolite support was mixed based on 100 parts by weight of an ABS resin, an extrudate was prepared using a single screw extruder under conditions of 240° C. and 200 rpm, and then the extrudate was cut to prepare a three dimensional printing material in a pellet form.

### Example 2

The three dimensional printing material was prepared in the same manner as in Example 1 except that the content of the reducing agent was adjusted to 3 parts by weight.

### Example 3

The three dimensional printing material was prepared in the same manner as in Example 1 except that the content of the reducing agent was adjusted to 5 parts by weight.

### Comparative Example 1

The three dimensional printing material was prepared in the same manner as in Example 1 except that the reducing agent was not mixed, and the cutting process was omitted.

### Experimental Example 1

The concentration of VOCs of the surrounding environment was measured while an arbitrary molded product was prepared using the three dimensional printing materials prepared in Examples 1 to 3 and Comparative Example 1 through an FDM method, and the result was shown in Table 1 as below.

TABLE 1

| | | O- | | | | |
|---|---|---|---|---|---|---|
| Classification | M,p-xylene | xylene | Toluene | Styrene | Benzene | Ethylbenzene |
| Example 1 | N.D. | N.D. | 18.4 | 30.7 | N.D. | 2.02 |
| Example 2 | N.D. | N.D. | 18.2 | 35.0 | N.D. | 2.21 |
| Example 3 | N.D. | N.D. | 5.18 | 30.9 | N.D. | 2.78 |
| Comparative | N.D. | N.D. | 1.42 | 45.9 | N.D. | 13.5 |
| Example 1 | | | | | | |

(Unit: ppm)

Referring to Table 1, xylene and benzene were not detected from the surrounding environment while the molded product was prepared using the three dimensional printing materials prepared in Examples 1 to 3 and Comparative Example 1. Further, the concentration of toluene of the surrounding environment while the molded product was prepared using the three dimensional printing materials prepared in Examples 1 to 3 was higher than that of the case of Comparative Example 1, but the concentrations of other VOCs such as styrene and ethyl-benzene were lower, and thereby the concentration of the corresponding harmful substance was determined to be reduced.

### Example 4

5 parts by weight of a reducing agent (average particle size: 5 μm) in which Na as a catalyst metal was supported on a zeolite support was mixed based on 100 parts by weight of an ABS resin, an extrudate was prepared using a kneader under condition of 240° C., and then the extrudate was cut to prepare a three dimensional printing material in a pellet form.

### Example 5

5 parts by weight of a reducing agent (average particle size: 5 μm) in which Na as a catalyst metal was supported on a zeolite/silica composite support (α-quartz, rhombohedral SiO₂, 20 wt %) was mixed based on 100 parts by weight of an ABS resin, an extrudate was prepared using a kneader under condition of 240° C., and then the extrudate was cut to prepare a three dimensional printing material in a pellet form.

### Experimental Example 2

The concentration of VOCs of the surrounding environment was measured while an arbitrary molded product was prepared using the three dimensional printing materials prepared in Examples 4 and 5 through an FDM method, and the result was shown in Table 2 as below.

TABLE 2

| | | O- | | | | |
|---|---|---|---|---|---|---|
| Classification | M,p-xylene | xylene | Toluene | Styrene | Benzene | Ethylbenzene |
| Example 4 | N.D. | N.D. | N.D. | 4.73 | N.D. | N.D. |
| Example 5 | N.D. | N.D. | N.D. | 4.24 | N.D. | N.D. |

(Unit: ppm)

Referring to Table 2, toluene and ethylbenzene were not detected from the surrounding environment while the molded product was extruded using the three dimensional printing materials prepared using a kneader in Examples 4 and 5, and the concentration of styrene in the case of Examples 4 and 5 were significantly lower than that in the case of Examples 1 to 3. Accordingly, it may be determined that the effect of reducing harmful substances was enhanced as compared to the case of Example 3 in which a single screw extruder was used.

This may be determined due to the greater effect of increasing the dispersibility of the reducing agent of the kneader used in Examples 4 and 5 as compared to that of the single screw extruder used in Examples 1 to 3. Further, when the results of Examples 4 and 5 are compared, the concentration of styrene in the case of Example 5 in which a zeolite/SiO₂ composite support was used as the support of the reducing agent was relatively lower than that in the case of Example 4, and it is determined that this is because SiO₂ used in the support partially contributed to improving the dispersibility of the reducing agent.

### Example 6

The three dimensional printing material was prepared in the same manner as in Example 4 except that the kneader was replaced by a twin screw extruder while preparing the extrudate.

### Example 7

The three dimensional printing material was prepared in the same manner as in Example 5 except that the kneader was replaced by a twin screw extruder while preparing the extrudate.

### Experimental Example 3

The concentration of VOCs of the surrounding environment was measured while an arbitrary molded product was prepared using the three dimensional printing materials prepared in Examples 6 and 7, and Comparative Example 1 through an FDM method, and the result was shown in Table 3 as below.

TABLE 3

| | Comparative | Example 6 | | Example 7 | |
|---|---|---|---|---|---|
| | Example 1 | Concentration | Reduction | Concentration | Reduction |
| VOCs | (μg/m³) | (μg/m³) | rate (%) | (μg/m³) | rate (%) |
| Benzene | 261 | 17 | 93.5 | 146 | 44.1 |
| Toluene | 492 | 481 | 2.2 | 307 | 37.6 |
| Ethylbenzene | 389 | 266 | 31.6 | 168 | 56.8 |
| Xylene | 273 | 200 | 26.7 | 217 | 20.5 |
| Styrene | 4,853 | 2,512 | 48.2 | 918 | 81.1 |
| Formaldehyde | 255 | 210 | 17.6 | 211 | 17.3 |
| Acetaldehyde | 240 | 222 | 7.5 | 232 | 3.3 |
| Acrolein | 15 | 14 | 6.7 | 14 | 6.7 |

Referring to Table 3, in the case of the three dimensional printing materials prepared in Examples 6 and 7, each of the concentration of benzene and styrene was significantly lower than that in the case of Comparative Example 1, and thereby the effect of reducing the concentration of the corresponding harmful substance was determined to be excellent.

Further, when comparing the results of Examples 6 and 7, in the case of Example 7 in which the zeolite/SiO₂ composite support was used as the support of the reducing agent, the concentration of styrene was much lower than that in the case of Example 6. Consequently, it was reconfirmed that SiO₂ used for the support improves the dispersibility of the reducing agent, and thereby the performance of reducing harmful substances of the three dimensional printing material may be enhanced.

### Example 8

5 parts by weight of a reducing agent (average particle size: 5 μm) in which Na as a catalyst metal was supported on a zeolite/silica composite support (β-quartz, hexagonal SiO₂, 20 wt %) was mixed based on 100 parts by weight of an ABS resin, an extrudate was prepared using a twin screw extruder under condition of 240° C., and then the extrudate was cut to prepare a three dimensional printing material in a pellet form.

### Example 9

5 parts by weight of a reducing agent (average particle size: 5 μm) in which Na as a catalyst metal was supported on a zeolite/silica composite support (α-tridymite, orthorhombic SiO₂, 20 wt %) was mixed based on 100 parts by weight of an ABS resin, an extrudate was prepared using a twin screw extruder under condition of 240° C., and then the extrudate was cut to prepare a three dimensional printing material in a pellet form.

### Experimental Example 4

The concentration of VOCs of the surrounding environment was measured while an arbitrary molded product was prepared using the three dimensional printing materials prepared in Examples 8 and 9, and Comparative Example 1 through an FDM method, and the result was shown in Table 4 as below.

TABLE 4

| | Comparative | Example 8 | | Example 9 | |
|---|---|---|---|---|---|
| | Example 1 | Concentration | Reduction | Concentration | Reduction |
| VOCs | (μg/m³) | (μg/m³) | rate (%) | (μg/m³) | rate (%) |
| Benzene | 232.45 | 10.65 | 95.42 | 15.34 | 93.40 |
| Toluene | 297.02 | 140.24 | 52.78 | 169.02 | 43.10 |
| Ethylbenzene | 285.09 | 135.52 | 52.46 | 185.09 | 35.08 |
| Xylene | 248.90 | 106.34 | 57.28 | 104.36 | 58.07 |
| Styrene | 3,390.47 | 339.75 | 89.98 | 255.30 | 92.47 |
| Formaldehyde | 63.32 | 48.26 | 23.78 | 52.75 | 16.70 |
| Acetaldehyde | 36.76 | 32.88 | 10.56 | 33.71 | 8.30 |
| Acrolein | 19.40 | 7.53 | 61.20 | 4.17 | 78.53 |

Referring to Table 4, in the case of the three dimensional printing materials prepared in Examples 8 and 9, each of the concentration of harmful substances which are measurement targets was lower than that in the case of Comparative Example 1, and it was determined that the three dimensional printing materials prepared in Examples 8 and 9 have similar reduction effects on overall harmful substances rather than specifically acting on specific harmful substances.

Especially, the reduction effects in the case of Examples 8 and 9 were largely improved as compared to the case of Example 7, and thus it may be determined that the structure of SiO₂ applied to the reducing agent affected the dispersibility of the reducing agent and the performance of reducing harmful substances of the three dimensional printing material. More specifically, it was determined that hexagonal and orthorhombic SiO₂ used in Examples 8 and 9 resulted in more excellent dispersibility of the reducing agent and the performance of reducing harmful substances of the three dimensional printing material as compared to rhombohedral SiO₂ used in Example 7.

The three dimensional printing filament composition according to the embodiment of the present invention includes a reducing agent and a photocatalyst, and thus may reduce harmful substances which may be generated during the composition preparation process or from final products to protect the environment and the health of users.

Further, a separate process of removing harmful substances may be omitted in the filament preparation process, resulting in effectively extending the range of application of 3D printer technologies to various fields.

Effects of the present invention are not limited to the above-described effects, and it should be understood that the effects include every effect that can be deduced from the configuration of the present invention disclosed in the detailed description or claims of the present invention.

The above description is only exemplary, and it will be understood by those skilled in the art that the invention may be performed in other concrete forms without changing the technological scope and essential features. Therefore, the above-described embodiments should be considered as only examples in all aspects and not for purposes of limitation. For example, each component described as a single type may be realized in a distributed manner, and similarly, components that are described as being distributed may be realized in a coupled manner.

The scope of the present invention is defined by the appended claims, and encompasses all modifications or alterations derived from meanings, the scope and equivalents of the appended claims.

What is claimed is:

1. A three dimensional printing filament composition for reducing harmful substances, comprising:
a thermoplastic resin at 100 parts by weight; and
at least one selected from a reducing agent in which a catalyst is supported on a support, and a photocatalyst at 0.1 to 10 parts by weight.

2. The composition of claim 1, wherein the support is one selected from the group consisting of zeolite, silica, alumina, sodium chloride, glass beads, activated carbon, and a mixture of at least two thereof.

3. The composition of claim 1, wherein the support has an average diameter in a range of 1 to 50 μm.

4. The composition of claim 1, wherein the catalyst is one selected from the group consisting of calcium, zinc, sodium, copper, nickel, chromium, manganese, iron, vanadium, palladium, platinum, ruthenium, rhodium, gold, silver, Fe—Mo alloy, Fe—Mo—Ti alloy, Co-Fi-Mo alloy, As—Nb—Mo alloy, Bi—Mo alloy, Fe—Sb alloy, Mg—Ge alloy, Mg—Fe alloy, and a mixture of at least two thereof.

5. The composition of claim 1, wherein the catalyst has an average diameter in a range of 10 to 100 nm.

6. The composition of claim 1, wherein the photocatalyst is one selected from the group consisting of anatase titanium dioxide, rutile titanium dioxide, zinc oxide, cadmium sulfide, zirconium oxide, vanadium oxide, tin oxide, tungsten oxide, and a mixture of at least two thereof.

7. The composition of claim 1, further comprising a reinforcing agent at 5 to 80 parts by weight based on 100 parts by weight of the thermoplastic resin, the reinforcing agent being one selected from the group consisting of graphene, carbon nanotubes, carbon fibers, glass fibers, metal powders, ceramic powders, and a mixture of at least two thereof.

8. A method of preparing a three dimensional printing filament composition for reducing harmful substances, comprising:
(a) preparing a mixture by mixing 100 parts by weight of a thermoplastic resin, and 0.1 to 10 parts by weight of a reducing agent in which a catalyst is supported on a support or a photocatalyst (S100);
(b) preparing an extrudate by extruding the mixture using a single screw extruder or a twin screw extruder (S200); and
(c) cutting and pelletizing the extrudate (S300).

9. The method of claim 8, wherein the support is one selected from the group consisting of zeolite, silica, alumina, sodium chloride, glass beads, activated carbon, and a mixture of at least two thereof.

10. The method of claim 8, wherein the support has an average diameter in a range of 1 to 50 μm.

11. The method of claim 8, wherein the catalyst is one selected from the group consisting of calcium, zinc, sodium, copper, nickel, chromium, manganese, iron, vanadium, palladium, platinum, ruthenium, rhodium, gold, silver, Fe—Mo alloy, Fe—Mo—Ti alloy, Co-Fi-Mo alloy, As—Nb—Mo alloy, Bi—Mo alloy, Fe—Sb alloy, Mg—Ge alloy, Mg—Fe alloy, and a mixture of at least two thereof.

12. The method of claim 8, wherein the catalyst has an average diameter in a range of 10 to 100 nm.

13. The method of claim 8, wherein the photocatalyst is one selected from the group consisting of anatase titanium dioxide, rutile titanium dioxide, zinc oxide, cadmium sulfide, zirconium oxide, vanadium oxide, tin oxide, tungsten oxide, and a mixture of at least two thereof.

14. The method of claim 8, wherein 5 to 80 parts by weight of a reinforcing agent is further mixed based on 100 parts by weight of the thermoplastic resin in step (a), the reinforcing agent being one selected from the group consisting of graphene, carbon nanotubes, carbon fibers, glass fibers, metal powders, ceramic powders, and a mixture of at least two thereof.

15. The method of claim 8, wherein a ratio of length to diameter of the extruder is in a range of 25 to 50:1.

16. The method of claim 8, wherein a driving speed of the extruder is in a range of 50 to 500 rpm.
